(19) United States
(12) Patent Application Publication
(10) Pub. No.: US 2025/0279687 A1
(43) Pub. Date: Sep. 4, 2025

(54) ELECTRIC MOTOR AND COMPONENTS

(71) Applicant: THE UNIVERSITY OF NOTTINGHAM, Nottingham (GB)

(72) Inventors: Chris GERADA, Nottingham (GB); David GERADA, Nottingham (GB); Zeyuan XU, Nottingham (GB); Tianjie ZOU, Nottingham (GB); Fengyu ZHANG, Nottingham (GB)

(21) Appl. No.: 19/047,778

(22) Filed: Feb. 7, 2025

Related U.S. Application Data
(63) Continuation of application No. PCT/GB2023/052078, filed on Aug. 7, 2023.

(30) Foreign Application Priority Data
Aug. 8, 2022 (GB) 2211509.1

(51) Int. Cl. H02K 3/28; H02K 1/16; H02K 3/12; H02K 5/20; H02K 15/0643

(52) U.S. Cl. CPC H02K 3/28; H02K 1/16; H02K 3/12; H02K 5/20; H02K 15/0643

(57) ABSTRACT

An electric machine comprising a rotor and a stator, wherein at least one of the rotor and/or stator comprises a toroidal winding comprising a plurality of preformed conductors.

### FIELD OF THE INVENTION

The present invention relates to electric machines and components for electric machines.

### BACKGROUND

The development of electric motors is an important aspect of society's transition from fossil fuels to renewable energy resources. In the aerospace industry in particular, there is an urgent need to develop electric motors that have performance characteristics suitable for use on aircraft. A fundamental characteristic that is especially important for aerospace applications is power density (kW/kg). Improving the power density of electric motors would also provide benefits for other sectors, such as automotive and motorsport.

One area for improvement is in the fundamental design of electric motors' armature winding. The winding or coil is typically the highest source of power loss in an electric motor. In high power applications, the winding generates a substantial amount of heat with high electrical resistance. In order to achieve high power density in an electric motor, electrical resistance is required to be minimized to reduce the losses and the generated heat in the winding needs to be effectively dissipated. Solutions for achieving this can result in considerable additional weight, which makes very high power density difficult to attain.

It can be challenging to manufacture electrical motors. For example, integrating the electrical windings with the stator or rotor of an electrical motor may be difficult. For continuously wound motors, limitations in bend radius may be imposed by bending of the conductor that forms the winding. Such limitations may lead to inefficiencies due to longer, more resistive windings, and may also result in less efficient field coupling.

Although considerable progress in the development of electric motors has been made, further improvement is needed in a number of these areas.

### SUMMARY

According to a first aspect, there is provided a winding portion configured for use in an electric machine, comprising a plurality of preformed conductors,
wherein the plurality of preformed conductors comprises:
   a first preformed conductor with a male feature, and
   a second preformed conductor comprising a female feature,
   herein the male feature is configured to be received in the female feature in order to connect the first preformed conductor with the second preformed connector.

A performed conductor may be defined as a conductor that has a pre-formed shape that differs from that of a conventional wire (a conventional wire having uniform cross sectional area along its length), such as a “hairpin” shape. The pre-formed conductor may be L-shaped, U-shaped or S-shaped. A pre-formed conductor may be pre-formed to conform with at least a portion of the stator. A pre-formed conductor may have at least one corner (for example linking an end section to an axial section of the conductor). Such preformed conductors enable geometric shapes for the winding that are better optimised for cost weight and/or performance. For example, tightly curved shapes (i.e. with small radius of curvature) can be achieved without straining the winding. Discontinuous transitions in direction are possible (e.g. 90 degree turns). The length of conductors can thereby be minimised, reducing parasitic resistive loss (from regions of the winding that do not contribute to field coupling between the a rotor and stator). Furthermore, complex and variable cross section geometry becomes straightforward to achieve, which may enable improved cooling (e.g. using a lumen with the conductor, adding fins or other features to the winding).

The male and female parts that interconnect the preformed conductors may simplify construction of an electric machine, particularly a high performance electric machine.

Herein, an electric machine may comprise a motor or a generator.

The male feature may comprise a pin (or other similar protrusion, such as a ridge), and the female feature may comprise a hole (or a similar recess, such as a slot).

The hole may be a through hole. In other embodiments a blind hole or groove may be used for the female feature.

The first preformed conductor may comprise a first axial conductor of the winding portion, and the second preformed conductor may comprise an end conductor configured to connect the first axial conductor with a second axial conductor. Alternatively, the second preformed conductor may comprise the first axial conductor, and the first preformed conductor may comprise the end conductor.

At least one of the performed conductors may comprise a step.

The end conductor may comprise an axial step, varying an axial position of the end conductor (with respect to the electric machine and with “axial” referring to an axis of rotation of the electric machine) and/or a lateral step (e.g. to deviate the end conductor between adjacent turns and/or slots of a winding of the electric machine) varying a circumferential position of the end conductor.

The male feature may be welded or soldered to the female feature.

The male feature may be a pin and the female feature may be a hole, and the pin may comprise a pin end portion that protrudes from the hole when engaged therewith.

The pin end portion may be twisted or bent to secure the first preformed conductor to the second preformed conductor.

According to a second aspect, there is provided an electric machine comprising a rotor and a stator, wherein the rotor and/or the stator comprises a winding portion according to the first aspect (including any optional features thereof).

The electric machine may comprise a stator comprising the winding portion according to the first aspect, including any optional features thereof, wherein the stator is toroidally wound.

According to a third aspect, there is provided an electric machine comprising a rotor and a stator, wherein at least one of the rotor and/or stator comprises a toroidal winding. The toroidal winding may comprise a plurality of preformed conductors (but this is not essential).

A pre-formed conductor may be defined as a conductor that has a pre-formed shape that differs from that of a conventional wire wrapped around the rotor and/or stator, e.g. “hairpin” shaped. The pre-formed conductor may be L-shaped, U-shaped or S-shaped. A pre-formed conductor may be pre-formed to conform with at least a portion of the stator, and may have at least one corner (for example linking an end section to an axial section of the conductor). Such preformed conductors enable geometric shapes for the winding that are better optimised for cost weight and/or performance. For example, tightly curved shapes (i.e. with small radius of curvature) can be achieved without straining the winding. Discontinuous transitions in direction are possible (e.g. 90 degree turns). The length of conductors can thereby be minimised, reducing parasitic resistive loss (from regions of the winding that do not contribute to field coupling between the a rotor and stator). Furthermore, complex and variable cross section geometry becomes straightforward to achieve, which may enable improved cooling (e.g. using a lumen with the conductor, adding fins or other features to the winding).

The toroidal winding may comprise a winding portion according to the first aspect.

The stator may comprise the toroidal winding.

The stator may further comprise a stator core having a back side facing away from the rotor and a front side facing towards the rotor. The toroidal winding may comprise a plurality of turns, each turn having a back portion adjacent to the back side of the stator core and a front portion adjacent to the front side of the stator core, the back portion and the front portion linked by an end portion.

The stator core may comprise a plurality of slots configured to receive the toroidal winding, each slot comprising a radial opening facing the rotor.

Each slot may receive only a single turn of the winding. In some embodiments, multiple windings may be disposed in each slot.

At least some of the plurality of preformed conductors may be U-shaped conductors, wherein each U-shaped conductor comprises:
a front portion of a turn;
a back portion of a turn; and
an end portion connecting the front portion and the back portion

At least some of the plurality of preformed conductors may be L-shaped conductors, wherein each L-shaped conductor comprises:
a front portion or a back portion of a turn; and
an end portion for connecting the front portion of the L-shaped conductor to a back portion of an adjacent turn, or for connecting the back portion of the L-shaped conductor to a front portion of an adjacent turn

At least some of the plurality of preformed conductors may be S-shaped conductors, wherein each S-shaped conductor is configured to provide an end portion linking a front portion with a back portion of the winding.

At least one end portion may comprise two straight sections offset from each other by an angled linking section. At least one end portion may comprise a straight section such that the end portion is cuboidal.

The shape of the preformed conductors may be arranged to improve cooling. For example, preformed windings for positioning on the back of the stator may have a different shape/cross area compared to conductors at the front of the stator (e.g. larger cross section at the back side). At least one cooling protrusion may be provided on a surface of the preformed conductor. A cooling hole (or lumen) may be provided that extends at least partially through the preformed conductor.

The preformed conductors for positioning on the back of the stator, may be configured to be parallel with the conductors in the slot, or at a non-zero angle to the longitudinal axis of the motor. This affects the shape of end-portions that connect different axial conductors.

The electric machine may further comprise a housing for the stator. The housing may at least partly define a fluid container for coolant in direct contact with winding portions at the front side or the stator and/or the rear side of the stator.

The housing may comprise:
a first end plate;
a second end plate;
a sleeve adjacent the front side of the stator core; and/or
a stator shell adjacent to the back side of the stator core.

The sleeve, first end plate, and second end plate may at least partly define a fluid container for coolant in direct contact with winding portions at the front side of the stator.

The stator shell, first end plate, and second end plate may at least partly define a fluid container for coolant in direct contact with winding portions at the back side of the stator.

The housing may further comprise a plurality of nozzles configured to circulate a coolant fluid in the fluid container. The nozzles may be configured to direct a flow of the coolant fluid onto a portion of at least some of the preformed conductors. The portion of the at least some of the preformed conductors may comprise an angled region, wherein the angled region is configured such that the flow of coolant fluid is redirected by the angled region onto an adjacent preformed conductor. The angled region may be an angled linking portion.

A coolant channel may be at least partly defined by the winding. For example, a coolant channel may be defined by the stator back and/or a back portion of the toroidal winding, and by the stator core and/or a front portion of the winding. The stator back may have grooves or slots that are configured to receive the back portion of the winding. The grooves may form part of the coolant channel. The groves may also be used to locate the back portion on the stator back, and at least partially fix the position of the back portion of the winding. This may reduce vibration of the back portion of the winding.

The slots of the stator core may also be large enough relative to the front portions of the toroidal winding that coolant fluid is able to flow within the slots, such that the front portions are also in contact with the coolant fluid.

At least some of the preformed conductors may comprise an angled region, wherein the angled region is configured such that a flow of coolant fluid is redirected by the angled region onto an adjacent preformed conductor.

At least some winding portions at the back side of the stator conductors may have:
at least one cooling protrusion on a surface of the preformed conductor; and/or
a cooling hole that extends at least partially through the preformed conductor.
a larger cross sectional area compared to the conductors in the slot.

Some of the plurality of preformed conductors may be extended end portions, configured to connect a winding portion at a slot to a winding portion at a non-adjacent slot.

The toroidal winding may comprises three or six phases. The stator may comprise at least 100 slots or at least 200 slots.

The toroidal winding may not be insulated (the conductor of the toroidal winding may not be coated in shellac, for example, or otherwise sleeved or coated with an electrically insulating material).

The stator core may comprise an insulating material covering surfaces of the stator that may contact the toroidal winding.

The insulation material may be a ceramic coating.

The toroidal winding may not be coated or sleeved with an insulator. The stator core may comprise an insulating material covering surfaces of the stator that may contact the toroidal winding. The insulating material may be a ceramic coating.

According to a fourth aspect, there is provided an electric machine comprising:
a stator comprising a plurality of slots and a toroidal winding disposed at least partly in the plurality of slots; and
a rotor;
wherein the toroidal winding comprises a single conductor in each of the plurality of slots.

The electric machine of the fourth aspect may include any of the features described with reference to the third aspect.

According to a fifth aspect, there is provided a method of manufacturing an electric machine, the electric motor comprising:
a toroidal winding;
a stator comprising a plurality of slots; and
a rotor;
wherein the toroidal winding comprises a plurality of performed conductors;
wherein the method comprises:
inserting at least some of the plurality of conductors into the slots;
joining the plurality of preformed conductors to form the toroidal winding.

The preformed conductors may be welded directly together to form the toroidal winding. In some embodiments the end portions may be long enough that their ends can be brought together to form the toroidal winding (e.g. by bending/crimping/welding etc). In some embodiments an end potion may be dispensed with, and essentially axial preformed conductors connected directly together

According to a sixth aspect, there is provided a method of manufacturing an electric machine in accordance with the second, third or fourth aspect (including any optional features thereof). The stator comprises a plurality of slots. The method comprises: i) inserting at least some of the plurality of conductors into the slots, and ii) joining the plurality of preformed conductors to form the toroidal winding.

Joining the plurality of preformed conductors to form the toroidal winding may comprise welding (or may comprise bending or twisting a pin end portion (as described with reference to the first aspect). Inserting at least some of the plurality of conductors into the slots may comprise inserting conductors in an axial direction into the slots. The insertion and/or joining may be automatically performed, for example by a robot. The preformed conductors may comprise connecting portions that slot together (e.g. a protrusion on one part and a corresponding hole for receiving the protrusion on another part, as described with reference to the first aspect, including any optional features thereof). The method may comprise assembling the preformed conductors by slotting them together.

The method may avoid bending the winding. End portions of the winding may be formed by joining an end portion to a front or back portion. This approach reduces the length of the end portion that may be necessary if the end portion is formed from bending.

Joining the windings may comprise welding the preformed conductors together. Joining the windings may comprise mechanically deforming the preformed conductors (e.g. crimping, twisting or bending).

According to a seventh aspect, there is provided a vehicle comprising a motor according any preceding aspect. The vehicle may be an aircraft. The aircraft may be autonomous or capable of carrying flight crew and optionally passengers. The aircraft may be a rotorcraft or a fixed wing aircraft. The aircraft may have a range of at least 100 miles or at least 1000 miles.

### DETAILED DESCRIPTION

Embodiments of the invention will be described, purely by way of example, with reference to the accompanying drawings, in which:

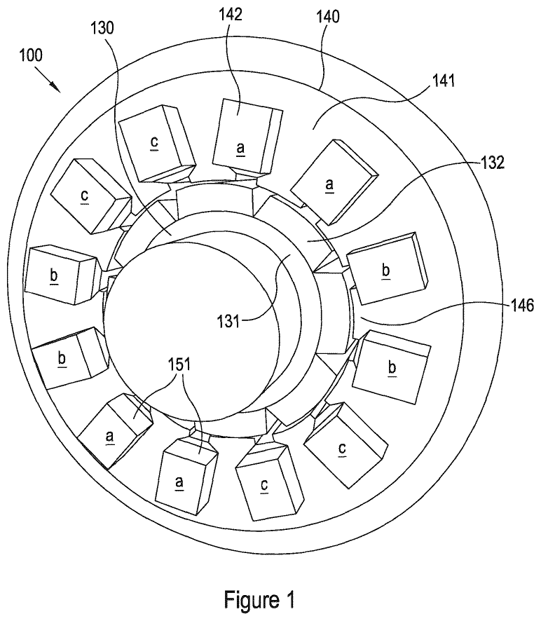

FIG. 1 shows an electric motor according to an embodiment of the present invention;

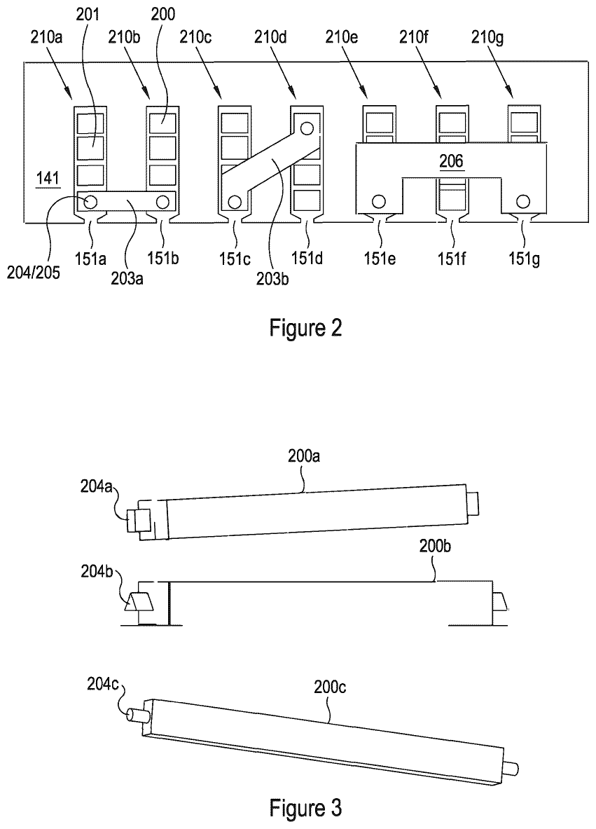

FIG. 2 shows a schematic of a portion of a stator core and winding portions;

FIG. 3 shows example preformed conductors each comprising only an axial portion;

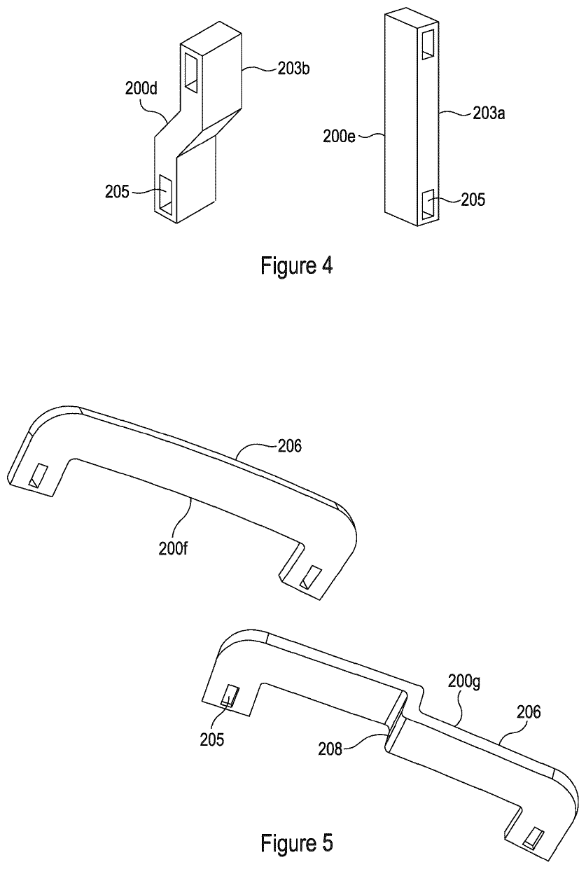

FIG. 4 shows example preformed conductors each comprising only an end portion;

FIG. 5 shows example preformed conductors each comprising only an extended end portion;

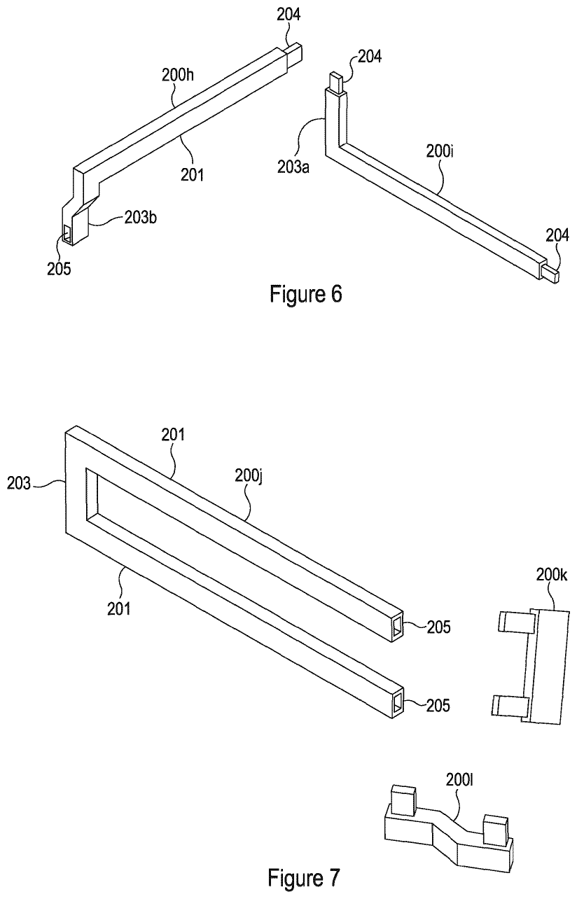

FIG. 6 shows example L-shaped preformed conductors each comprising an axial portion and an end portion;

FIG. 7 shows a U-shaped preformed conductors with a corresponding end portion;

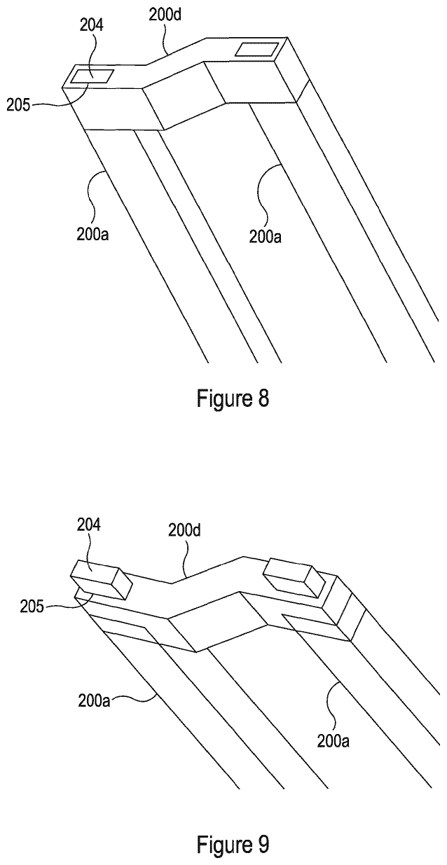

FIGS. 8 and 9 show examples of engaged preformed conductors;

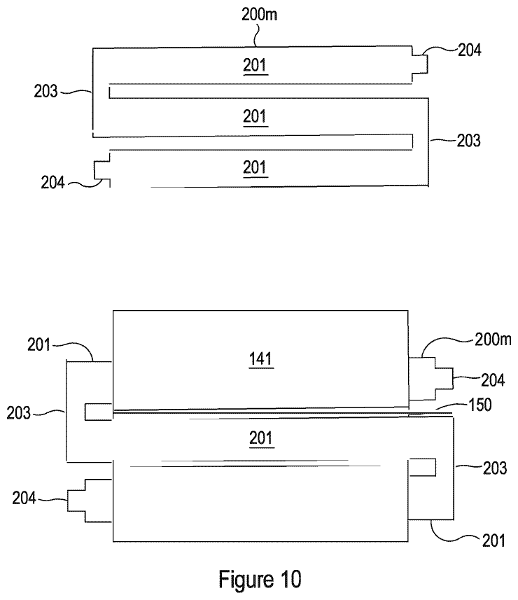

FIG. 10 shows a serpentine preformed conductor;

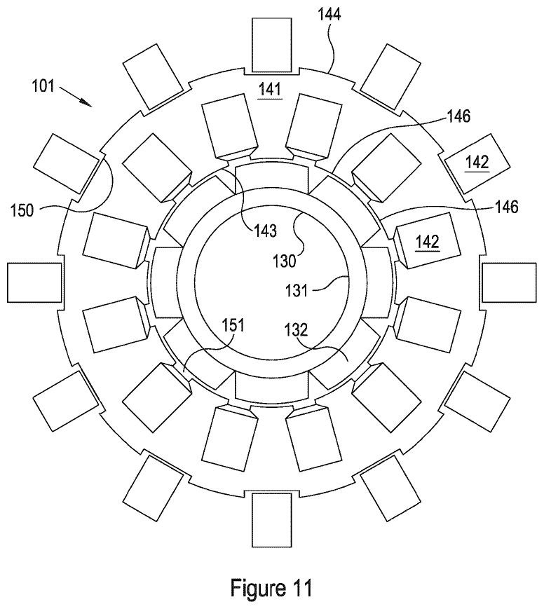

FIG. 11 shows an example electric motor with a toroidal winding;

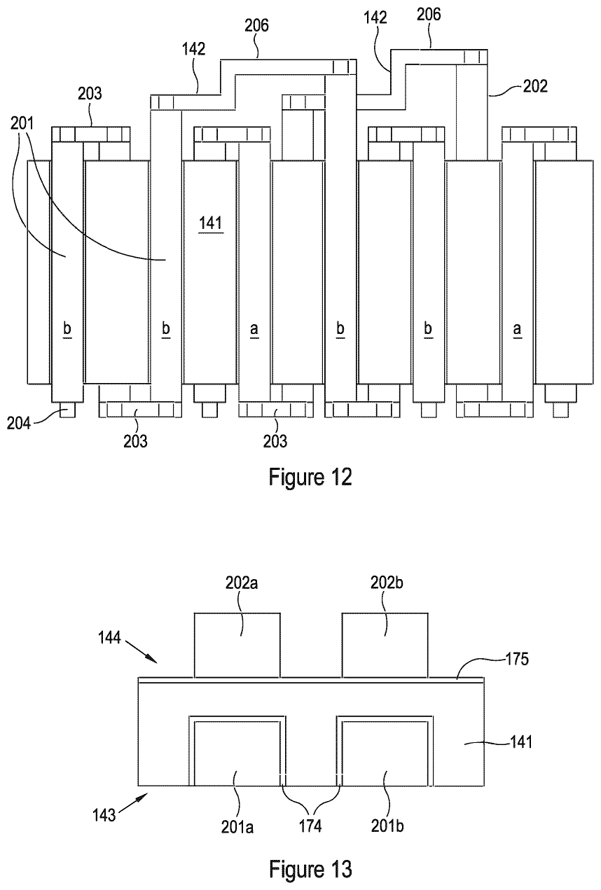

FIG. 12 shows an example of how conductors may be connected to form a toroidal winding;

FIG. 13 shows a cross section of a stator core and winding according to an embodiment;

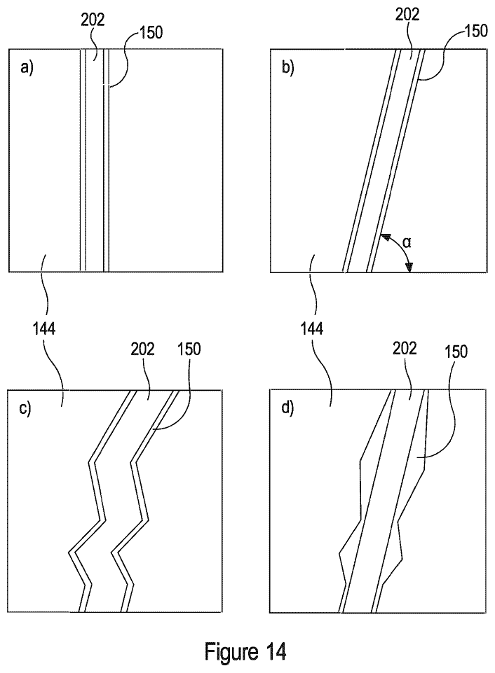

FIG. 14 shows examples of stator back arrangements with different shaped back portions of the winding;

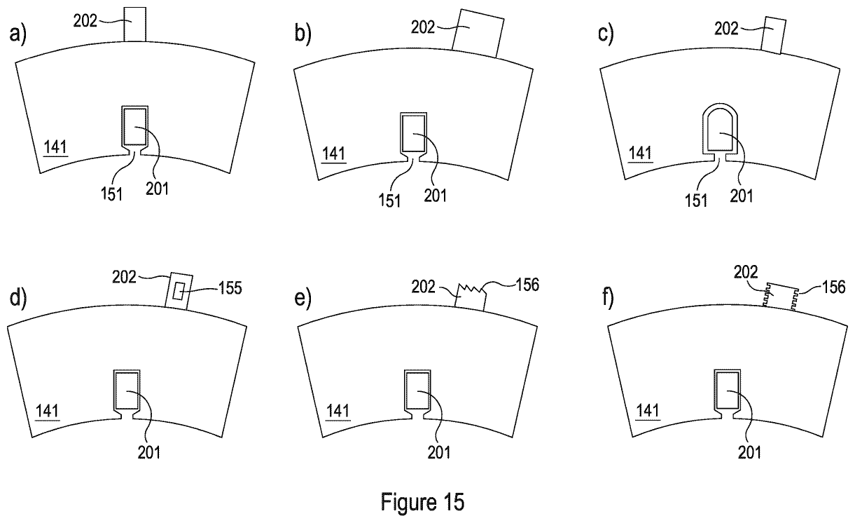

FIG. 15 show example cross sections of performed conductor back portions;

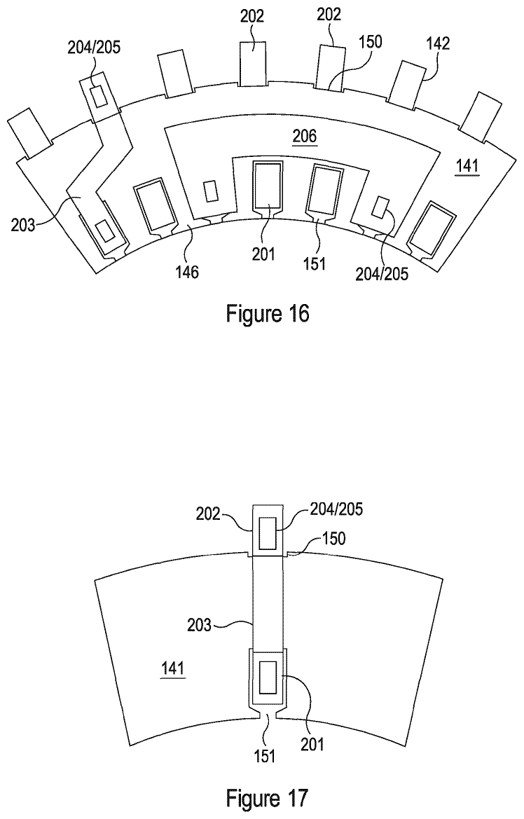

FIG. 16 shows a portion of a stator core and toroidal winding;

FIG. 17 shows an example arrangement of a front portion and back portion of a toroidal winding and end portion;

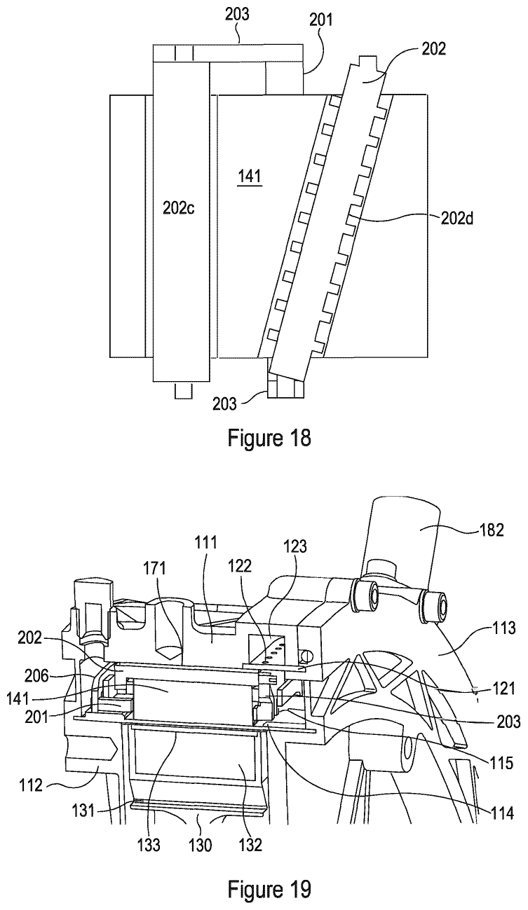

FIG. 18 shows a winding portion with a first back portion that is axial and a second back portion that is angled and comprises cooling fins;

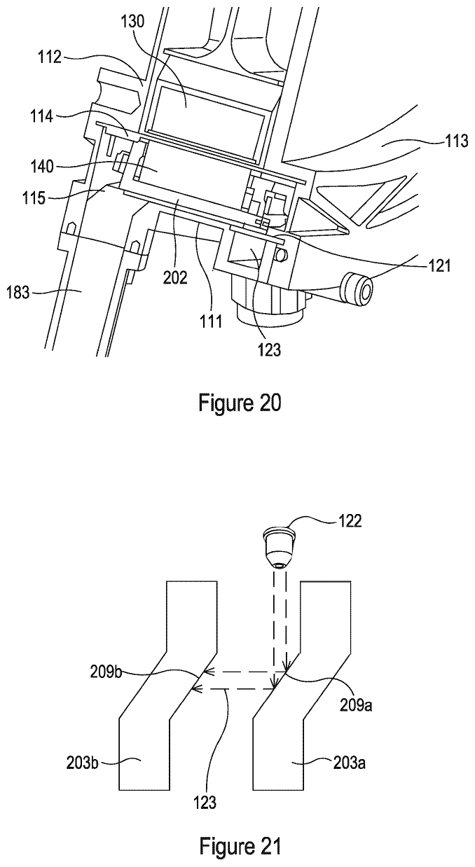

FIGS. 19 and 20 show an example embodiment of a toroidally would motor, illustrating a cooling thereof;

FIG. 21 shows circulation of cooling fluid over preformed end portions; and

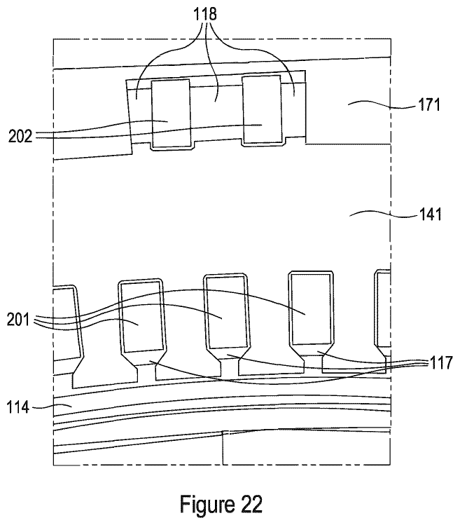

FIG. 22 shows a cross section of an electric motor showing cooling channels at the front side and back side of the stator.

Referring to FIG. 1, an example electric motor 100 is shown in schematic view. The electric motor is a permanent magnet synchronous motor, having a rotor that comprises permanent magnets, and a stator comprising windings and stator poles.

The rotor 130 comprises a rotor hub 131, on which a plurality of permanent magnets 132 are situated in order to produce the magnetic poles of the rotor 130. In this example the number of rotor magnetic poles is 8. A rotor sleeve (not shown in FIG. 1) may be provided to cover or contain the magnets 132. Such a rotor sleeve 133 may be made from carbon or carbon composite.

The electric motor 100 further comprises a stator 140. The stator 140 comprises a stator core 141 and at least one winding 142. The winding 142 in this example embodiment is disposed in slots in the stator core 141 that face the rotor 130. Each slot comprises an opening, facing the rotor. In this embodiment there are 12 slots, but any number of slots may be used in other embodiments (e.g. more than 100 or more than 200 slots). Between the slots, stator poles 146 are defined.

The winding 142 may be configured with a three phases, a, b and c, for example as shown in FIG. 1. In other embodiments a different number and arrangements of phases may be used (e.g. 6 phases). In the embodiment of FIG. 1, a concentrated winding is used, in which the number of stator poles 146 is equal to the number of slots 151, and each stator pole 146 is wrapped with a coil formed in the slots 151. Other embodiments may comprise an electric machine (e.g. motor) with a distributed winding.

In embodiments the windings are made from preformed conductors, as will be explained with reference to FIGS. 2 to 10.

FIG. 2 shows a schematic of a portion of a stator core 141 and winding portions 210a-g, which have been drawn here with rectilinear geometry for ease of representation (it should be understood that the slots 151 in a rotational electric machine would be radial). Each of the winding portions 210a-g is illustrative of approaches that can be used to form the winding of an electric motor according to an embodiment. In an electric machine according to an embodiment, a consistent approach would tend to be used for the winding portions, and the arrangement of phases would also tend to be consistent.

Each winding portion 210a comprises preformed conductors 200. Axial portions 201 of the preformed conductors 200 are disposed in their respective slot 151a. Axial portions 201 in adjacent slots 151a,b are linked with an end portion 203a. Axial portions in adjacent slots 151c,d are linked with an end portion 203b. End portion 203a is straight, linking axial portions 201 at the same radial position in their respective slot 151. End portion 203b is angled, linking axial portions 201 at different radial positions in their respective slots 151.

The angled end portion 203b may be referred to as an S-shaped preformed conductor. The S-shaped preformed conductor may have the shape of an oblong that has a first bend, defining a transition from a first straight section to an angled linking section and a second bend, defining a transition from the angled linking section to the second straight section. The straight sections are parallel, and oriented radially when assembled, so the angled linking section is at a non-zero angle to the radial direction in the assembled motor.

Axial portions in non-adjacent slots 151e,g are linked by extended end portion 206.

Combinations of axial portions, end portions and extended end portions can be used to construct windings with any desired number of slots, stator poles, and winding types (distributed or concentrated, conventional or toroidal).

As illustrated in FIG. 2, the preformed conductors are connected together by means of corresponding male and female features. A first preformed conductor comprised a male feature 204 (e.g. a pin) and a second preformed conductor comprises a female feature 205 (e.g. a hole) for receiving the male feature 204. Insertion of the male feature 204 into the female feature 205 connects the first and second preformed conductors (e.g. an axial portion of a first preformed conductor with an end portion of a second preformed conductor). Preferably, the male feature 204 and female feature 205 are axial (i.e. parallel with the electric machine rotational axis), so that all of the preformed connectors 200 can readily be assembled by moving them axially (e.g. with a robot or other automatic assembly system). Similarly, the axial portions of the preformed conductors 200 may be inserted into their respective slot in an axial direction. This approach may simplify the construction of a winding (and may be applied to create a high performance motor).

FIG. 3 shows example preformed conductors 200a-c that each comprises only an axial portion. Each of the preformed conductors 200a has a male feature (pin) 204a-c at each end. Any cross sections may be used for the male and female features, as illustrated by these examples which include male features with rectangular cross section 204a, triangular cross section 204b and circular cross section 204c.

FIG. 4 shows examples of preformed conductors 200d,e that each comprise only an end portion. Preformed conductor 200d comprises an angled end portion 200d. Performed conductor 200e comprises a straight end portion 200e. Both preformed conductors 200d,e comprise an axial through hole 205 at each for receiving a corresponding pin of an axial portion of at least one other preformed conductor. The holes 205 in these examples are rectangular, but any shape can be used (corresponding with the male part of the preformed conductor to be connected).

FIG. 5 shows examples of preformed conductors 200f,g that each comprise only an extended end portion 206. Preformed conductor 200f is flat (e.g. in a plane normal to the axial direction), and preformed conductor 200g comprise a step 208. The step 208 results in the extended end portion having two axial levels, which may allow the preformed conductor 200g to avoid contact with other preformed conductors (e.g. adjacent end portions or adjacent extended end portions), so that insulation is not needed. Both preformed conductors 200f,g again comprise axial through holes 205 at each end, for connecting with an axial pin of an axial portion of a further preformed conductor.

FIG. 6 shows example L-shaped preformed conductors 200h,i that comprise both an axial portion 201 and an end portion 203. Preformed conductor 200h comprises an angled end portion 203 with a hole 205 at an end thereof for receiving a pin of a further preformed conductor (e.g. a pin of an axial portion of the further preformed conductor). The axial portion 201 of preformed conductor 200h and 200i comprises an axial pin 204, which may be received in a corresponding hole of an end portion of another preformed conductor. Preformed conductor 200i comprises a straight end portion 203a that comprises a non-axial pin 204 (which may project in any direction, e.g. radially or circumferentially).

It is not essential that axial portions 201 always comprise male features 204 and end portions always comprise female features 205. In some embodiments a recess may be provided at an end of an axial portion of a preformed conductor for receiving a corresponding protrusion of an end portion of a further preformed conductor. FIG. 7 shows a U-shaped preformed conductor 200j, comprising a first and second axial portion 201 connected by an end portion 203 at a first end. At the second end of the performed conductor 200j, a female feature (e.g. recess) 205 is provided for receiving a corresponding male feature 204 of a further preformed conductor, such as preformed conductors 200k or 200l. Preformed conductors 200k,l each consist only of an end portion which is provided at each end a male feature (pin) 204 for engagement with the female features 205 of preformed conductor 200j.

It should be understood that the combinations of features for the preforms are merely illustrative, and U-shaped preforms with male connecting features are contemplated, as well as L-shaped preforms with female connection features.

FIG. 8 shows a first preformed conductor 200a engaged with a second preformed conductor 200d, by engagement of a pin 204 of preform 200a with hole 205 of preform 200d. A third preformed conductor 200a is likewise engaged with a further hole of preform 200d. In another embodiment, the axial positions visible in this figure may be each part of a U-shaped preformed conductor.

The male and female features of respective preformed conductors may be configured with a clearance fit. In order to maintain engagement and/or to provide low contact resistance at interfaces between preformed conductors, joined preformed conductors may be soldered or welded together once assembled. For example, laser welding may be employed to automatically weld preformed conductors together. This may be straightforward where all the connections are axially oriented. In other embodiments, preformed conductors may be crimped or otherwise mechanically deformed to perform a similar function.

FIG. 9 shows an example, which includes all the features of FIG. 8, but in which the male pins 204 protrude from their corresponding female features after engagement therewith. The protruding portions of the male pins 204 may be twisted or bent so as to achieve a low resistance and mechanically secure connection between the preformed conductors.

Not all preformed conductors according to embodiments are necessarily configured for axial insertion. FIG. 10 illustrates a preformed conductor 200m comprising three axial portions 201, linked by two end portions 203. The axial portions may be configured to be received in different (e.g. adjacent) slots of an electric machine (e.g. motor).

The preformed conductor 200m is shown wound around a stator core 141. The stator core may be segmented such that the preformed conductor 200m can be attached to the stator core. A plurality of the segmented stator core 141 and preformed conductor 200m sections may be fabricated and then coupled together to produce a full stator/winding ring. The stator core 141 may comprise grooves 150 on the back side that are configured to at least partially receive the back portions of the conductor 200m.

The use of preformed conductors in electric machines according to embodiments, and particularly the end portion 203 (whether independently in straight or S-shaped conductor or part of a U-shaped or L-shaped conductor) may reduce the amount of end winding material. In a conventional winding (not employing pre-formed portions) changes in direction are limited by a minimum radius of curvature. End portions in a conventionally wound coil are therefore longer, since an abrupt transition from axial to radial directions is not possible in a conventionally wound arrangement. The use of pre-formed conductors is synergistic with the use of conductors with relatively large cross sectional area, and very compact designs. Preformed large cross-section conductors are straightforward to handle, assemble and weld together (following assembly, for example by laser welding).

Preformed conductors 200 may be made from copper. The preformed conductors may be manufactured using a variety of techniques. Each preformed conductor is made from a single piece of material, so as to reduce connections and therefore electrical resistance. Each preformed conductor may be cut to shape, for example using laser cutting or machining. Alternatively, each conductor could be ‘stamped’ as a flat component and reshaped where necessary (e.g. to form the angled end portion 203).

At least a portion of (e.g. all of) a winding of an electric machine (e.g. as shown in FIG. 1, or FIG. 11, or any embodiment described herein) can be assembled from preformed conductors like those shown in FIGS. 2 to 10. The combination of preformed conductors that are appropriate can be selected based on the particular requirements for the electric machine. Preformed conductors like those described herein can, for example, be used to make an electric motor with high power density. Such an electric motor may be capable of producing at least 100 KW of mechanical power at the output shaft (e.g. 300 kW). In some embodiments the electric motor 100 may be at least a 1 MW (e.g. 2 MW) electric motor (i.e. capable of producing at least 2 MW of mechanical power). The motor 100 may be capable of rotational speeds of 6000 rpm or more. The electric motor 100 may have a power density exceeding 10 kW/kg or 15 kW/kg

The use of preformed conductors and connecting extended end portions as shown in FIGS. 2 to 10 may reduce the electrical resistance of a winding of an electric machine. The preformed conductors and connectors may be designed so that they slot together with good electrical contact, and so that they are sufficiently rigid that short circuits between different portions of the winding will not occur under rated shock and vibration conditions.

In certain embodiments, preformed conductors (e.g. of the type described above) may be used to create an electric machine (e.g. motor) with a toroidal winding, for example with a toroidally wound stator.

An example of a motor 101 comprising is a toroidally wound stator is schematically shown in FIG. 11. The electric motor 101 is a permanent magnet synchronous motor, having a rotor that comprises permanent magnets, and a stator comprising windings and a plurality of stator poles.

The rotor 130 comprises a rotor hub 131, on which a plurality of permanent magnets 132 are situated in order to produce the magnetic poles of the rotor 130. In this example the number of rotor magnetic poles is 8. A rotor sleeve (not shown in FIG. 11) may be provided to cover or contain the magnets 132. Such a rotor sleeve 133 may be made from carbon or carbon composite.

The electric motor 100 further comprises a stator. The stator comprises a stator core 141 and at least one winding 142. The winding 142 is toroidal, so comprises conductor portions both disposed in slots 151 in the front side 143 of the stator core 141 that faces the rotor 130, and on the back side 144 of the stator core 141 that faces away from the rotor 130. The toroidal winding 142 comprises a plurality of toroidal turns.

Each turn comprises a back portion that is adjacent to the back side 144 of the stator, a front portion that is adjacent to the front side 143 of the stator, and an end portion that links the back portion and the front portion.

Each slot 151 comprises an opening, facing the rotor 130. In this example there are 12 slots, but any number of slots may be used in other embodiments (e.g. more than 100 or more than 200 slots). Between the slots, stator poles 146 are defined. The winding portions on the back side of the stator core 141 may be disposed in grooves (or back slots) 150.

In some embodiments, each slot 151 may house a plurality of turns of the winding 142 (e.g. similar to FIG. 2). Alternatively, each slot 151 may house only a single conductor of the winding 142. Where each slot 151 houses only a single conductor of the winding 142, insulation may not be required on the conductor of the winding. In some embodiments it may be useful to insulate the surface of the stator core 141 (where the stator core 141 comprises a conductive material, such as a laminated iron core).

One advantage of using a single conductor per slot 151 that that the winding conductor is not in contact with other turns of the winding. This means that the conductor can be uninsulated, and that insulation can be provided only between the stator core and the winding. As each turn of the winding is physically separated, there is no possibility that the turns may contact and short the winding. There is still a need to provide insulation between the winding and the stator core 141, but this may be provided by coating the stator core 141 itself. The lack of winding insulation may result in reduced weight of the motor, and increased heat transfer from the winding to the coolant. The use of stator core insulation may also make the motor more suitable for safety critical applications, such as aerospace. The stator core insulation may be manufactured from a hard, abrasion resistant material, such as ceramic (e.g. alumina, aluminium nitride). This insulation may be more resistant to wear and degradation than enamelled windings, where turns may rub against each other due to motor vibrations, thereby wearing away the enamel. Insulation may only be provided on portions of the stator core that are in contact with the winding. For example, back insulation may not be provided on the portions of stator core 141 between adjacent back portions 202. This may reduce the amount and weight of insulation used.

The insulation may be made with a ceramic material with high thermal conductivity (approximately 170 W/m·K). This may result in more efficient heat transfer between the preformed conductors (particularly the front portion 201 which is surrounded by the slot) and the stator core 141 than traditional slot liners made from materials such as Nomex 410 (with a thermal conductivity of just 0.2 W/m·K).

In this example, the slots 151 are configured such that the front axial portion of the winding in the slot is substantially surrounded by the stator core 141. The slots 151 have a radial opening (facing the rotor) that may be narrower than a width of the preformed conductor used, so that the preformed conductor front portion must be inserted into the slot axially, rather than radially. Insertion of the preformed conductor in the axial direction enables a greater degree in flexibility in slot design, which may in turn enable improved cooling and higher performance by enhanced flux coupling.

FIG. 12 provides an example of a winding portion configuration for a motor like that shown in FIG. 11. The winding portion comprises an assembly of preformed conductors as described with reference to FIGS. 2 to 10. Axial front portions 201 of the winding 142 at the front side 143 are shown in front of the stator core 141, and the stator core 141 partially obscures axial back portions 202 of the winding 142 at the back side 144 of the stator core 141.

Each of the axial portions of the winding are similar to those shown in FIG. 3, having male features for connection with corresponding female features of preformed end portions 203 (like those of FIG. 4) which link adjacent front portions 201 and back portions 202 of the winding. Extended end portions 206 (like those of FIG. 5) connect winding portions in non-adjacent positions (e.g. front slots or back grooves) in the same phase.

The winding portion shown here comprises phases a and b. The arrangement of conductors in these phases is merely illustrative-any connection of winding portions into phases is possible.

In the examples of FIGS. 11 and 12, the front portion 201 of a winding lies on a different radius than the subsequent back portion 202 of the winding. Each end portion connecting a front portion 201 to a back portion 202 of the winding starts at one radial location and ends at a different radial location. This is not essential-in other embodiments the front portion 201 may be connected using a straight (radial) end portion to a back portion 202 on the same radius as the front portion.

As shown in FIG. 11 (not visible in FIG. 12), the back side of the stator 144 may comprise slots or grooves 150 in which the back portions 202 of the winding are seated. The slots 150 may form part of a coolant channel and/or may at least partially fix the position of the back portions.

FIG. 13 shows an example embodiment showing a cross section of a stator core 141 normal to the motor axis. Front conducting portion 201a is at the same radial location as back conducting portion 202a. In this example an insulating layer 174 is shown on the front portion in the slot 155, insulating the front portions 201a,b from the stator core 141, and an insulting layer 175 is shown insulating the back portions 202a,b from the stator core 141.

Unlike the front portions 201a, 201b, the back portions 202a, 202b are not surrounded on three sides by the stator core 141 and are instead left exposed (on three sides) on the back side 144. This may allow for more effective cooling of the toroidal winding via these back portions 202a, 202b, as coolant fluid can directly contact the toroidal winding on the back side 144 and can be easily circulated through the open spaces between/around back portions 202a, 202b (e.g. guided by a stator back 171, as shown in FIGS. 20 and FIG. 22).

Cooling can be a significant performance factor in electric machines. An achievable power density may be, at least in part, defined by how much heat can be dissipated from the winding of the machine. In certain embodiments, an electric machine is provided in which a cooling fluid is in direct contact with conducting elements of the winding. For example, in the embodiment of FIG. 1, coolant may circulate in the slots 151 to cool the windings. A sleeve (not shown in FIG. 1) may be provided between the stator 140 and the rotor, and end plates at both axial ends of the stator 140 may define a fluid container for containing the coolant fluid. The coolant fluid may be circulated in contact with the winding, for example in an axial direction.

In embodiments that employ a toroidal winding (like that of FIG. 11), the back portions of the winding may also be cooled by a cooling fluid in direct contact with the winding. In some embodiments, the back portions 202 of the winding and/or the stator core 141 may be designed to improve cooling.

FIG. 14 shows some examples of stator back arrangements comprising a back groove 150 and back portion 202 of the winding. The groove 150 and back portion 202 may together define a coolant channel for coolant fluid to circulate and cool the winding and/or stator core.

In FIG. 14a, the back portion 202 of the winding is axial, and is disposed in a groove 150 in the stator core. In FIG. 14b, the back portion 202 of the winding and the stator groove 150 are at a non-zero angle (alpha) to the axial direction. In FIG. 14c, the back portion of the winding 202 and the stator groove 150 comprises a plurality of zig-zag portions. In FIG. 14d, the back portion of the winding 202 is prismatic and straight, but the stator groove 150 varies in width, so as to increase a surface area of the stator core in contact with the coolant fluid. The use of a non-zero angle alpha may mean that the end portion are straight, as shown in some of the following examples.

In general, there may be fewer constraints on back portions of a toroidal winding, since flux generated from the back portions of the winding may make a less significant contribution to the performance of the motor. There is also may be more room as the back side of the rotor in embodiments in which the rotor is radially inwards from the stator, so there may be more space for design adaptations for improvement of cooling.

FIGS. 15a-c show alternative configurations of the preformed conductor back portions 202 arranged on the back side of the stator core 144. FIG. 15a shows a configuration wherein the back portion 202 and coolant channel 150 are configured to be at an angle a relative to the axial direction of the stator core. The angle a means that the ends of the front 201 and back 202 conductors are vertically above one another, so a straight end portion can be used to connect them.

As shown in FIG. 15b, and similar to those discussed previously, back portions 202 and corresponding coolant channels (defined by back side groove 150) may be parallel to the axial direction of the stator core. As discussed previously, a staggered or angled end portion may be used to connect the front 201 and back 202 conductors.

FIG. 15c shows a further alternative configuration, wherein the back portion 202 and coolant channel 150 have at least one bend or curve. These alternatives may be used for some or all of the preformed conductors.

FIGS. 15a-f show alternative configurations of the preformed conductors and slots 151 arranged on the stator core 141.

As shown in FIG. 15a, the slots 151 may be configured such that front portions 201 and back portions 202 are directly opposite each other on opposing sides of the stator core 151. FIG. 15b shows an alternative configuration, where the slots 151 are configured such that the front portions 201 and back portions 202 are diagonally offset from each other.

The dimensions of the back portion 202 and/or front portion 201 may be made smaller or larger, and may not be the same. As shown in FIG. 15b, the back portions 202 may be made larger than the front portion 201. Increasing the size of the back portion 202 would result in a larger external surface area and smaller electrical resistance, which may increase heat dissipation and/or reduce resistive losses. Surface area may also be increased by changing the shape of the preformed conductors, e.g. by making them protrude further from the back of the stator core 141.

FIG. 15c shows an alternative configuration wherein the front portions 201 and slots 151 have a rounded shape. The slots and/or preformed conductors may be shaped so that insertion of the preformed conductors easier.

Preformed conductors may have holes that pass at least part of the way through the preformed conductor. FIG. 15d shows a back portion 202 with a hole 155 that runs along the length of the back portion 202. The hole 155 increases the surface area of the back portion 202, and allows coolant fluid to run axially through the back portion 202, which may improve heat dissipation.

Preformed conductors may also be provided with protrusions or fins on external surfaces. Again, the protrusions would increase the surface area of the conductors, which may improve heat dissipation. FIG. 15e shows a back portion 202 with a plurality of protrusions 156 on the back surface. FIG. 15f shows a back portion 202 with a plurality of fins on the side surfaces.

FIG. 16 shows portion of a stator comprising a stator core 141 and toroidal winding 142. The toroidal winding 142 comprises front portions 201, back portions 202, end portions 203 and extended end portions 206. The stator core 141 comprises slots 151, facing the rotor (not shown). Within each slot 151 is disclosed a single preformed conductor front portion, which may be configured to be inserted axially into the slot 151. The slot opening is narrower than the width of the conductor front portion 201.

A turn of the winding may be formed from a front portion 201, back portion 202 and end portions 203. Extended end portions 206 are used to connect winding conductors that are not in adjacent slots 151.

FIG. 17 shows an example arrangement of a front portion 201 and rear portion of a toroidal winding in which the front and back portion are on the same radius (as described with reference to FIG. 13.

FIG. 18 shows a winding portion viewed from the back side of a stator core 141, the winding portion comprising a plurality of preformed conductors. The preformed conductors comprise front portion 201, first back portion 202c, second back portion 202d. An end portion 203 connects the front portion 201 to the first back portion 202c. The end portion 203 may be similar to the conductor 200d shown in FIG. 4. A further end portion 203 connects the front portion 201 to the second back portion 202d. The further end portion 203 may be similar to the conductor 200e shown in FIG. 4. The first back portion 202c is axial and has unform cross section within the stator back groove. The second back portion 202d is at a non-zero angle to the stator axis, and comprises fins to increase the surface area of the back portion 202d with any coolant fluid circulating in the region of the stator back. The connections between the different portions of the winding are made using male and female portions on respective preformed conductors, as discussed with reference to the example preforms shown in FIGS. 2 to 10.

FIGS. 19 and 20 show an example embodiment of a toroidally wound electrical motor, illustrating cooling fluid circulation. In this example an example motor housing is shown. As discussed in previous examples, the toroidal winding comprises preformed conductors, which may comprise front portions 201, back portions 202, end portions 203 and extended end portion connectors 206.

The housing comprises a stator shell 111, an end plate 112 and a coolant sleeve 114 which define a toroidal housing region. The housing may be made from or comprise A16061-T5 or other aluminium alloys. Alternatively, the motor housing may comprise other aerospace materials, such as titanium or carbon composites.

The coolant sleeve 114 is made of a material that is impermeable to coolant fluid, such as fibre glass composite. A second end plate 133 is attached to the stator shell 111, such that a fluid container 115 is defined, capable of containing a coolant fluid. The fluid container 115 is configured to house the stator (comprising the stator core 141 and winding). The fluid container 115 allows for coolant fluid to be passed over the back portion of the toroidal winding in order to dissipate heat generated by resistive heating. The stator core slots may also comprise coolant channels for coolant fluid to be passed over the front portions within the slots.

The direct contact between the conductors of the winding and the coolant, and the immersion of the back windings in coolant improve heat dissipation from the motor, enabling very high power density. A stator back 171 may be provided (but is not essential) to further contain coolant in contact with the back of the stator in order to cool the winding and to insulate the winding from the stator shell 111. The stator back 171 may be made from a plastic such as PEEK or PTFE.

The end plate 112 may comprise an end plate hole (not shown) allowing a drive shaft to be connected to the rotor of the motor. Such an end plate hole may be provided on one of or both of the end plates. Bearings for the axle/drive shaft may be fitted within the end plate hole or connected to the end plate 112 around the end plate hole (or bearings external to the motor may be used to control the position of the shaft and rotor within the stator).

The housing 110 comprises a coolant inlet 182 for providing coolant to the enclosed housing region that surrounds the toroidal winding, and a coolant outlet 183 for draining coolant from the housing 110. A jet ring 121 is shown in FIG. 20, which is an optional feature that may assist with cooling. The jet ring 121 comprises a series of nozzles and is configured to distribute the cooling fluid circumferentially in the fluid container 115. In other examples, there may be no jet ring. Instead, coolant may be supplied into the housing 110 through the cooling inlet 182 such that the winding/stator are substantially immersed in fluid. The volume around the winding may be substantially filled with fluid.

A subsection of the region defined by the housing may function as a coolant gallery 123. The coolant gallery 123 is separated from the rest of the fluid container 115 by jet ring 121. Coolant fluid may be supplied to the coolant gallery 123 by an inlet 182 situated in the stator shell 111 of the housing. The jet ring 121 may comprise a plurality of holes or nozzles 122 that pass coolant fluid from the coolant gallery 123 to the fluid container 115. The nozzles 122 may be situated adjacent to end portions 203 of the toroidal winding so that coolant fluid is injected at sufficient speed to circulate in the region of the end connectors near the jet ring 121, as shown in FIG. 21. A nozzle 122 may be provided for each end portion 203, for example (but this is not essential). The jet ring 121 and other components of the coolant system may be manufactured from an inert, corrosion resistant material, such as stainless steel. After the coolant fluid circulates over the end portion, it is communicated through back fluid channels defined by the stator back 171, back winding portions 202 and stator core 141 and via front fluid channels defined by the front winding portions, stator core 141 and the coolant sleeve 114. The coolant subsequently cools the end portions at the opposite end of the stator, before exiting the fluid container 115 via coolant port 183. In addition to cooling the winding back portions and end portions by direct contact, the coolant fluid is also in direct contact with extended end portions that link the different segments of the motor.

The coolant used in the motor may be a fluid with high electrical resistance and high thermal conductivity, such as oil.

The housing may further comprise connectors or ports that allow for control and operation of the motor. These ports may include power connectors 181 configured to allow electrical power to be supplied to each phase of the toroidal winding.

The inlet 182 may be positioned near to a first axial end of the housing 110, and the outlet 183 near a second opposite axial end of the housing 110, so that coolant flows from the inlet 182 to the outlet 183 in an axial direction over (at least) the back portions of the stator winding.

Although described as comprising a stator shell 111, first end plate 112, second end plate 113 and a sleeve 114, other configurations of the housing are possible. For example, stator shell 111 and first end plate 112 may be one integral part, formed (e.g. machined) from the same material. Alternatively, the stator shell and first end plate 112 may be manufactured as separate components but then fixed together, for example by being welded together. Both examples may reduce the weight associated with fastening mechanisms. It is preferable that at least the second end plate 113 is removably fastened to the housing, so that the interior of the housing can be accessed easily.

FIG. 21 shows how preformed conductors can redirect a coolant fluid 123. Coolant fluid 123 is ejected from a nozzle 122 onto a preformed conductor, in this example an end portion 203a. The end portion 203a comprises an angled region 209a (i.e. angled away from a radial direction). End portion 203a may be an S-shaped conductor, or an end portion of a U-shaped or L-shaped conductor. The angled region 209a is configured such that when the stream of coolant fluid 123 intersects the end portion 203a, it is redirected towards an adjacent preformed conductor-end portion 203b. The end portion 203b may further comprise an angled region 209b, configured to again redirect the stream of coolant fluid 123. By configuring the nozzles 122 to be positioned so that coolant fluid is directed on to angled regions 209 of the preformed conductors, circulation fluid may more effectively remove heat from the conductors. This may improve the cooling of the toroidal winding.

FIG. 22 shows a cross section of the electric motor taken perpendicular to the motor axis. When the stator core 141 and windings are housed between the stator back 171 and sleeve 114, a fluid channel is defined around the preformed back conductors of the winding. Effective cooling channels 118 are formed around the back portions 201, as they protrude from the back side of the stator core 141. The front portions 121 are received by slots in the stator core 141, resulting in front coolant channels 117 that may be smaller than the back channels 118. The front coolant channels 117 may still provide adequate cooling to the front portions 201, particularly via the surface of the front portion 201 that is adjacent to the opening of the slot. Coolant movement within the front coolant channels 117 may constitute the majority of cooling but, as the front portions 201 are substantially surrounded by the stator core 141, some heat may also be dissipated into the stator core 141 itself.

The coolant channels 117, 118 may extend between areas of fluid containment at each end of the preformed conductors (i.e. a region of the fluid container adjacent to each of the housing end plates). Coolant fluid may be directed along the channels 117, 118 such that coolant runs along the length of each front portion 201 and back portion 202.

The example embodiments are radial flux motors, wherein magnetic flux is radially coupled between the winding of the stator and the magnets of the rotor. In some embodiments the motor may be an axial flux motor, wherein magnetic flux is axially coupled between the winding of the stator and magnets of the rotor.

Features of the invention such as the use of a toroidal winding, preformed conductors, the cooling system and manufacturing/assembly techniques are equally applicable to such embodiments.

Although electric motors have been described, it will be understood that the same principles are equally applicable to generators.

The example embodiments are not intended to limit the scope of the invention. which should be determined with reference to the accompanying claims.

What is claimed is:

1. An electric machine comprising a rotor and a stator, wherein at least one of the rotor and/or stator comprises a toroidal winding comprising a plurality of preformed conductors.

2. The electric machine of claim 1 wherein the stator comprises the toroidal winding.

3. The electric machine of claim 2, wherein:
the stator further comprises a stator core having a back side facing away from the rotor and a front side facing towards the rotor, and
the toroidal winding comprises a plurality of turns, each turn having a back portion adjacent to the back side of the stator core and a front portion adjacent to the front side of the stator core, the back portion and the front portion linked by an end portion.

4. The electric machine of claim 3, wherein the stator core comprises a plurality of slots configured to receive the toroidal winding, each slot comprising a radial opening facing the rotor.

5. The electric machine of claim 4, wherein each slot receives only a single turn of the winding.

6. The electric machine of claim 3, wherein:
i) at least some of the plurality of preformed conductors are U-shaped conductors, wherein each U-shaped conductor comprises:
a front portion of a turn;
a back portion of a turn; and
an end portion connecting the front portion and the back portion; and/or
ii) at least some of the plurality of preformed conductors are L-shaped conductors, wherein each L-shaped conductor comprises:
a front portion or a back portion of a turn; and
an end portion for connecting the front portion of the L-shaped conductor to a back portion of an adjacent turn, or for connecting the back portion of the L-shaped conductor to a front portion of an adjacent turn; and/or
iii) at least some of the plurality of preformed conductors are S-shaped conductors, wherein each S-shaped conductor is configured to provide an end portion linking a front portion with a back portion of the winding; and/or
iv) at least one end portion comprises two straight sections offset from each other by an angled linking section.

7. (canceled)

8. The electric machine of claim 3, further comprising a housing for the stator, the housing defining a fluid container for coolant in direct contact with winding portions at the front side and/or the back side of the stator.

9. The electric machine of claim 8, wherein the housing further comprises a plurality of nozzles configured to circulate a coolant fluid in the fluid container.

10. The electric machine of claim 9, wherein the portion of the at least some of the preformed conductors comprises an angled region, wherein the angled region is configured such that a flow of coolant fluid is redirected by the angled region onto an adjacent preformed conductor.

11. The electric machine of claim 2, wherein at least some winding portions at the back side of the stator conductors have:
i) at least one cooling protrusion on a surface of the preformed conductor; and/or
ii) a cooling hole that extends at least partially through the preformed conductor; and/or
iii) larger cross sectional area than winding portions not at the back side of the stator.

12. The electric machine of claim 1, wherein:
i) some of the plurality of preformed conductors are extended end portions, configured to connect a winding portion at a slot to a winding portion at a non-adjacent slot; and/or
ii) the toroidal winding comprises six phases and/or wherein the stator comprises at least 200 slots; and/or
iii) the toroidal winding is not coated or sleeved with an insulator and/or wherein the stator core comprises an insulating material covering surfaces of the stator that may contact the toroidal winding.

13. (canceled)

14. (canceled)

15. A method of manufacturing an electric motor, the electric motor comprising:
a toroidal winding;
a stator comprising a plurality of slots; and
a rotor;
wherein the toroidal winding comprises a plurality of performed conductors;
wherein the method comprises:
inserting at least some of the plurality of conductors into the slots;
joining the plurality of preformed conductors to form the toroidal winding.

16. A winding portion configured for use in an electric machine, comprising a plurality of preformed conductors,
wherein the plurality of preformed conductors comprises:
a first preformed conductor with a male feature, and
a second preformed conductor comprising a female feature,
wherein the male feature is configured to be received in the female feature in order to connect the first preformed conductor with the second preformed connector.

17. The winding portion of claim 16, wherein the male feature comprises a pin, and the female feature comprises a hole.

18. The winding portion of claim 16, wherein one of the first preformed conductor and the second performed conductor comprises a first axial conductor of the winding portion, and the other of the first preformed conductor and the second preformed conductor comprises an end conductor configured to connect the first axial conductor with a second axial conductor.

19. The winding portion of claim 18, wherein at least one of the performed conductors comprises a step.

20. The winding portion of claim 19, wherein the end conductor comprises an axial step varying an axial position of the end conductor and/or a lateral step varying a circumferential position of the end conductor.

21. The winding portion of claim 16, wherein the male feature is welded or soldered to the female feature.

22. The winding portion of claim 16, wherein the male feature is a pin and the female feature is a hole, and the pin comprises a pin end portion that protrudes from the hole when engaged therewith.

23. The winding portion of claim 22, wherein the pin end portion is twisted or bent to secure the first preformed conductor to the second preformed conductor.

24. (canceled)

25. (canceled)
